(19) United States
(12) Patent Application Publication
(10) Pub. No.: US 2007/0289494 A1
(43) Pub. Date: Dec. 20, 2007

(54) Size For The Treatment Of Glass Fibers, And Glass Fibers Provided With Said Sizes

(76) Inventor: Roman Teschner, Delitzsch (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/565,701

(22) PCT Filed: Jul. 22, 2004
(86) PCT No.: PCT/EP04/08181

§ 371 Date: Aug. 31, 2007

(30) Foreign Application Priority Data
Jul. 25, 2003 (DE) 103 33 941.8

(51) Int. Cl. C03C 25/26; C03C 25/28

(52) U.S. Cl. 106/287.11; 106/287.2; 106/287.24

(57) ABSTRACT

A size described for finishing glass fibers comprises merely a film-former, an adhesion promoter and also an acid for the purpose of adjusting the pH and water. The film-former used is preferably polyvinylpyrrolidone and the adhesion promoter, a γ-aminopropyltriethoxysilane hydrolyzed to the silanol. Acetic acid is preferred for acidifying. The glass fibers sized with this sizing composition are notable in particular for corrosion resistance and bear an uninterrupted layer of the film-former. The stiffness of the filaments thus sized is satisfactory. The fibers are very efficiently processsible as a dispersion by the wet-laying process and do not tend to agglomerate. The erasing fibers sized according to the invention are particularly useful.

This invention relates to a size for treating glass fibers and also to glass fibers sized with this size, including in particular thus sized erasing glass fibers.

Glass fibers are very well known. Glass fibers may be produced by processing a glass melt by the blast drawing, centrifugal spraying or mechanical drawing process for example. Glass fibers may be produced as so-called staple fibers, i.e., fibers having a certain length, or else as (continuous) filaments.

Glass fibers have to be provided with a so-called size in the course of their production. One function of this size is to protect the fibers from each other, i.e., to prevent their being damaged through attrition by mutual friction or cross fragmentation (breakage) due to mutual mechanical interaction.

A further function of the size is to facilitate the cutting of the fibers, in particular to help to achieve equal staple lengths. Furthermore, the size shall also prevent the agglomeration of fibers and, in particular, improve the. dispersibility of short fibers in water in order that uniform sheet materials may be obtained by the wet-laying process. The size shall also ensure good bonding between glass fibers and polymers in which the glass fibers act as a reinforcing component. This is of utmost importance for fiberglass-reinforced plastics, also known as GRPs.

Finally, a size shall also endow the glass fibers with a certain degree of suppleness and reduce the mutual friction of the filaments, in particular with regard to good further processing of the fibers into a variety of products.

The sizes hitherto developed for coating glass fibers generally comprise a whole series of constituents, namely film-formers, lubricants, wetters, adhesion promoters and so on.

The film-former endows the fiber bundle with integrity, it protects the glass filaments against mutual friction and it is also responsible for affinity for synthetic resin and hence for the strength and integrity of the composite material.

Film-formers are used in a fraction of 0.5% to 12% by weight, based on the entire size, and include starch derivatives, polymers and copolymers of vinyl acetate and acrylic esters, epoxy resin emulsions, polyurethane resins, polyamides.

The lubricant in the size endows the sized glass fibers and the glass fiber products with suppleness and reduces the mutual friction of the glass fibers not only in the course of the production process but also in the course of the further-processing operation. However, most lubricants impair the adhesion between glass and resin.

Lubricants used in an amount of 0.01% to 1% by weight include fats, oils, polyalkyleneamines.

The wetters likewise used in the known sizing compositions have the function to reduce the surface tension and to ensure improved wetting of the filaments with the size. Poly fatty acid amides, for example, are used as wetters in aqueous sizing compositions in an amount of 0.1% to 1.5% by weight for example.

Since most resins (polymers) do not have good affinity for glass, a so-called bridge has to be created between glass and resin to ensure better transmission of force in the composite in the case of composite materials. So-called adhesion promoters are used. Adhesion promoters enhance the adhesion of polymers to the glass surface.

Adhesion agents used include in most cases organofunctional silanes, examples being γ-aminopropyl-triethoxysilane, γ-methacryoyloxypropyltrimethoxysilane, γ-glycidyloxypropyltrimethoxysilane and the like.

Before the silanes are added to the aqueous size, they are usually hydrolyzed to silanols. A silanol reacts with the reactive surface of glass and forms, from the absorbing silanol, an adhesion-agent layer about 3 nm in thickness, which forms a protective veil over the fiber surface.

The protective veil is an oligomer which is initially still soluble and later condenses to form crosslinked structures and is finally, following a thermal treatment (drying), present as a siloxane (≡Si—O—Si≡). The hydrolyzate solution has only limited stability and tends to condense.

A further problem with sized glass fibers is their corrosion. When glass fibers, especially the comparatively more alkaline glass fibers of C-glass, come into contact with water, a process of corrosion ensues. The corrosion process is based on the glass surface being leached out and ablated and can be described using the following chemical reactions:
≡Si—O—Na+H₂O→≡Si—O—H+Na⁺+OH
≡Si—O—K+H₂O→≡Si—O—H +K⁺+OH

The alkali which is released in the process, such as NaOH or KOH for example, attacks the silica skeleton of the glass fibers and the following chemical process ensues:
Si—O—Si≡+OH→≡Si—O+≡Si—OH

EP 0 450 638 A1 describes a chemical composition which is said to be useful as a size for the finishing of glass fibers. This chemical composition comprises a water-soluble film-forming polymer having an intrinsic viscosity of less than around 150 mPas, an organo-functional trialkoxysilane, which is hydrolyzed completely, partially or else not at all, a cationic lubricant and also an epichlorohydrin polyamide reaction product and also water. The composition described therein, which is curable, is said to be particularly useful for improving the cuttability of the fibers. Improving the resistance to corrosion is not discussed in this European patent application, nor are erasing fibers mentioned.

It is an object of the present invention to provide a size which leads to sized glass fibers which are appreciably less prone to corrode, if at all. The invention further has for its object to provide a size which is simple to produce and satisfies the following requirements: viz. good fiber cuttability, good fiber wetting with the binder and also sufficient stiffness on the part of the filaments.

I have found that this object is achieved, surprisingly, by a glass fiber size comprising essentially in addition to water only a film-former, an adhesion promoter and an organic acid for establishing a pH in the acidic range.

The size preferably comprises polyvinylpyrrolidone as film-former. A γ-aminopropyltriethoxysilane hydrolyzed to the silanol is particularly useful as adhesion promoter.

Acetic acid is particularly useful as agent for setting a pH in the acidic range.

A particularly preferred embodiment of the size according to the present invention has the following composition: 0.02% to 0.08% by weight of polyvinylpyrrolidone, 0.3% to 0.5% by weight of γ-aminopropyltriethoxysilane, 0.18% to 0.24% by weight of acetic acid, the balance being water and the sum total of the constituents being 100%.

The aforementioned % ages by weight are based on the substance as such. To make up this preferred embodiment, polyvinylpyrrolidone is preferably employed as a 20% aqueous solution, the acetic acid is used in a concentration of 60%. The balance being water refers to the total amount of water which is present in the size and, to arrive at 100% constituents, total water is made up of the dilution water of polyvinylpyrrolidone, the dilution water in the 60% strength acetic acid and also the additional water added to make up to 100 parts.

The pH of the sizing composition of the present invention is preferably 4.5 to 5.0. The solids content of the size according to the invention, i.e., the fraction of film-former and adhesion promoter, is preferably between 0.3% and 0.6% by weight.

Erasing fibers are glass fibers used inter alia for polishing, for cleaning surfaces including screens of television sets or monitors, for polishing jewelry, for rust removal, etc. These erasing fibers are used in abrasive disks for example, but also find use in cleaning cloths and the like. They are fibers having a very fine linear density, for example a diameter in the region of 50 μm. Preference is given to fibers having a diameter of 30 to 70 μm.

The present invention further provides glass fibers sized with a size described above.

The present invention further provides erasing glass fibers sized with one of the above-described sizes.

The size of the present invention may be produced for example as follows. First, water is mixed with an appropriate amount of acetic acid, for example 60% strength acetic acid, and introduced as initial charge. Concurrently, γ-aminopropyltriethoxysilane is hydrolyzed with deionized cold water and some acetic acid to form the aminosilanol. The hydrolysis generally takes about 15 minutes. The hydrolysis mixture also obtained is added to the water acidified with acetic acid.

Polyvinylpyrrolidone is while stirring diluted with hot water and added to the batch. The rest of the water is added together, stirring is continued and the pH of the size determined.

The size thus obtained is immediately ready for sizing glass fibers.

It was particularly surprising that the size of the present invention not only enhances the corrosion resistance of fibers sized with it, but also does not impair fiber cuttability, erasability, fiber wetability, stiffness.

The fibers thus sized do not tend to agglomerate and are particularly useful as erasing fibers.

The example which follows illustrates the invention:

### EXAMPLE

150 kg of water and 680 g of acetic acid (60%) are introduced as initial charge. 800 g of γ-aminopropyltriethoxysilane (A1100) is hydrolyzed with 8 kg of deionized cold water and 20 g of 60% acetic acid to form the aminosilanol. The hydrolysis takes 15 minutes at room temperature. The hydrolyzate solution is then added to the acidified aqueous solution.

400 g of polyvinylpyrrolidone (K90 as 20% aqueous solution) is while stirring diluted in 8 kg of hot water and added to the batch. Further water (32.1 kg) is then added to increase to 100 parts. After further stirring, the pH is determined and the size is immediately ready to use.

The K90 polyvinylpyrrolidone used is a product of ISP Global Technology Deutschland GmbH, 50203 Frechen and the A1100 aminosilane used is a product of Witco Specialty Chemicals GmbH, 36396 Steinau a.d. Strasse.

1. A glass fiber size, characterized in that it comprises essentially in addition to water only a film-former, an adhesion promoter and an organic acid for establishing a pH in the acidic range.

2. A size according to claim 1, characterized in that the film-former is polyvinylpyrrolidone.

3. A size according to claim 1, characterized in that the adhesion promoter is a γ-aminopropyltriethoxysilane which has been hydrolyzed to the silanol.

4. A size according to claim 1, characterized in that the agent for setting a pH in the acidic range is acetic acid.

5. A size according to claim 1, characterized in that the composition of the size is 0.02% to 0.08% by weight of polyvinylpyrrolidone, 0.3% to 0.5% by weight of γ-aminopropyltriethoxysilane, 0.18 to 0.24% by weight of acetic acid, the balance being water and the sum total of the constituents being 100%.

6. A size according to claim 1, characterized in that the pH is 4.5 to 5.0.

7. A size according to claim 1, characterized in that the fraction of film-former and adhesion promoter in the size is between 0.3% and 0.6% by weight.

8. Glass fiber sized with a size according to claim 1.

9. Erasing glass fiber sized with a size according to claim 1.

10. A size according to claim 1, characterized in that:
a) the film-former is polyvinylpyrrolidone;
b) the adhesion promoter is a γ-aminopropyltriethoxysilane which has been hydrolyzed to the silanol;
c) the agent for setting a pH in the acidic range is acetic acid.

11. A size according to claim 10, characterized in that the composition of the size is 0.02% to 0.08% by weight of polyvinylpyrrolidone, 0.3% to 0.5% by weight of γ-aminopropyltriethoxysilane, 0.18 to 0.24% by weight of acetic acid, the balance being water and the sum total of the constituents being 100%.

12. A size according to claim 10, characterized in that the pH is 4.5 to 5.0.

13. A size according to claim 10, characterized in that the fraction of film-former and adhesion promoter in the size is between 0.3% and 0.6% by weight.

14. Glass fiber sized with a size according to claim 10.

15. Erasing glass fiber sized with a size according to claim 10.
